(19) United States
(12) Patent Application Publication
(10) Pub. No.: US 2023/0372933 A1
(43) Pub. Date: Nov. 23, 2023

(54) Method for Sample Collection and Metering

(71) Applicant: LMX MedTech LLC, Bloomfield, MI (US)

(72) Inventor: Michael J. Pugia, Pagosa Springs, CO (US)

(21) Appl. No.: 18/030,654

(22) PCT Filed: Oct. 7, 2021
(86) PCT No.: PCT/US2021/053982

§ 371 Date: Apr. 6, 2023

Related U.S. Application Data
(60) Provisional application No. 63/089,286, filed on Oct. 8, 2020.

(51) Int. Cl. B01L 3/00

(52) U.S. Cl. CPC B01L 3/50273; B01L 2300/0645; B01L 2300/0681; B01L 2200/16; B01L 2400/049

(57) ABSTRACT

A method for collection of complex samples and bio-analysis of the same. Specifically, a system having a porous wicking matrix, at least one capillary, analyte detection microwell was with porous surface and a filtration well, for bio-analysis of complex samples, which enable processing of biomolecule capture and/or immunoassay detection. The system allows for processing samples such as: wholeblood, serum, plasma, urine, wound fluid, bronchial lavage, and sputum. Amounts available for measure range from 0.1 μL to 1 mL.

### CROSS REFERENCE TO RELATED APPLICATIONS

This application is the United States national phase of International Application No. PCT/US21/53982 filed Oct. 7, 2021, and claims priority to U.S. Provisional Patent Application No. 63/089,286, filed Oct. 8, 2020, the disclosures of which is hereby incorporated by reference in their entireties.

### BACKGROUND OF THE INVENTION

### Field of the Invention

The present disclosure relates to a method for collection of complex samples and bio-analysis of the same. Specifically, the disclosure relates to bio-analysis of complex samples, which enable processing of biomolecules by capture and immunoassay detection. The disclosure relates to processing samples such as: whole blood, serum, plasma, urine, wound fluid, bronchial lavage, and sputum. Volumes of sample that can be processed range from 0.1 μL to 1 mL. The biomarkers can be whole cells or cell free markers.

The technology serves to meter volumes of sample while allowing dilution and mixing of samples with one or more secondary liquids, and, finally, allowing the sample to be moved and held in a sensor area to enable simplification of affinity assays and isolation methods.

Affinity assays such as immunoassays typically require multiple steps for incubation and washing. The sample to be analyzed is generally moved with a liquid, either a buffer or the sample fluid itself, through a porous matrix such as a filter paper used to collect the sample followed by a porous matrix such as a membrane used to capture the analyte measured. This requires both membrane and paper to be of similar capillary forces. In practice, this approach raises issues as the differences in capillary force are common between papers and membranes. Matching the capillary forces, also known as hydrodynamic forces, becomes difficult and is limited by length, width, and porosity of the materials used. For example, the use of size exclusion filtration membranes with small pores of <20 um requires significant vacuum forces to capture materials in complex fluid (Pugia Anal Chem 2021). Therefore, these designs are subjected to application of specialized cassettes with pressure applied to either the papers or membranes to adjust hydrodynamic force for the materials selected. This solution is prone to variation during assembly and must be modified for differences in papers and membranes.

An alternative solution is the application of an external hydrodynamic force to cause flow through the resistant membranes and papers. This solution however requires additional steps by the user or a mechanical system. This solution remains prone to variations in the differences in papers and membranes. An alternative solution is to seal and connect the membranes and papers in a microfluidic design, which encloses the papers and membranes in capillaries (Pugia 2004 Clin Chem). In this case, hydrodynamic forces applied can be adjusted using changes in the capillary forces to push the liquid through papers and membranes of different resistances. Immunoassays which utilize microfluidic capillary designs for sample and analyte capture do offer the ability to stop and restart the liquid flow during analysis by requiring application of increasing external hydrodynamic force after each step, such as by centrifugation speed or vacuum strength. This offers the advantages for timing reaction such as incubation and washing steps of affinity assays.

However, this microfluidic solution for affinity assay utilizes capillaries for moving sample and analyte, and is, therefore, prone to clogging due to the small capillaries sizes used, such as <1000 μm diameters or less. Additionally, the microfluidic capillaries needed to stop and to re-start flow typically become increasingly smaller at each step in the assay. These additional steps require achieving a separation of increasing hydrodynamic forces to break the capillary stops. For example, the capillary down-stream of the capture area must be much smaller than the capillary up-stream of the capture area, to allow stopping the liquid for incubation. This becomes problematic when the initial capillary needed for sample collection is very small due to sample sizes of a few μL. Accordingly, this further reduces the capillary stop size needed down-stream of the capture area which quickly becomes a problem by becoming clogged with debris from complex samples. It is therefore a benefit to eliminate any capillary stop function down-stream of the capture area.

Thus, it is desirable to create a method for collection and analysis of samples where the hydrodynamic force of the capillary down-stream of the capture area could be less and greater than 1000 μm in diameters, and, therefore, closer to the hydrodynamic force used to collect the sample. This would allow larger capillary to gather liquids and pass large sized debris, while not acting as a stop capable holding and releasing the sample and/or liquids during the additional incubating, mixing, and washing steps needed for affinity assay protocols.

### Description of Related Art

As described in U.S. Patent Application Publication No. 2018/0283998 to Pugia et al. (hereinafter “'998”), which is incorporated by reference in its entirety, a microfluidic capillary stop placed underneath a filtration membrane was successful in holding liquid on top of a filtration membrane, as shown in FIG. 3 of the same. After the sample is collected on the filtration membrane (15), the membrane (15) is removed and sealed into a microfluidic format to allow releasing of the liquid from the capillary stop. The microfluidic format includes a reaction well (14), filtration membrane (15), and a capillary stop (16). When hydrodynamic force is applied in the waste collection chamber (17), the force drives the sample and liquid reagent fluids through the reaction well (14), filtration membrane (15), and capillary stop (16). When hydrodynamic force is not applied, the capillary stop (16) can hold a liquid in the reaction well (14).

The steps for using the system of '998 begins with adding a sample to the sample capillary (10) followed by adding liquid reagent (9) to the sample well (8). The sample processing occurs by application of a hydrodynamic force in the waste collection chamber (17) that drives the sample and liquid reagent fluids (9) through the sample capillary (10) mixing with the liquid in the sample well (8) and then drives the diluted sample through the filtration membrane (15). The filtration membrane (15) is then attached to a second microfluidic format to place a capillary stop (16) underneath the filtration membrane (15). Vacuum or centrifuge force is used to generate a hydrodynamic force in the waste collection chamber (17) at desired strength to pull the analysis reagent into the collection chamber (17).

The '998 device can be used for affinity assays such as electrochemical immunoassays (EC-IA), optical immunoassays (OP-IA), and mass spectrometric immunoassays (MS-IA) in the detection of cells and biomolecules trapped on the filtration membrane (15). This format allows cells be immediately captured on the filtration membrane (15) by size exclusion. In other cases, biomolecules are captured on the filtration membrane (15) using microparticles with affinity agents attached. A second affinity agent is used for biomolecule detection. Descriptions of the affinity assays utilized may be found in Pugia, M. J. et al., “Multiplexed SIERRA Assay for the Culture-Free Detection of Gram-Negative and Gram-Positive Bacteria and Antimicrobial Resistance Genes” Anal Chem, 2021.

However, the '998 design suffers from the limitation of having to perform the capture on membrane with small pores of <20 um diameter prior to placement of membrane into a new microfluidic format for removal of liquid. The primary reason for this step was that a higher hydrodynamic force was needed to push the complex sample through the membrane and a higher the hydrodynamic force needed to hold liquid in the reagent well to allow incubation. Holding the liquid requires a capillary stop down-stream from the membrane. The capillary stop requires a capillary diameter of <1 mm. Decreasing the hydrodynamic force requires a capillary of greater than 1000 μm diameters

The '998 device also demonstrates that an additional sample well (see FIG. 2b, item 9) can be attached to the top of the reaction well (14) and can also include a sample capillary (10) at the bottom of the sample well (8) capable of holding the sample (10). The sample well (8) is snapped into the reaction well (14) prior to use and removed prior to detection. However, this '998 design still suffers from the limitations of having too small of a sample capillary (10), requiring higher hydrodynamic force up-stream from the filtration membrane (15). Again, this reduces the collection capillary diameter to <1000 microns diameter which quickly becomes a problem by becoming clogged with debris from the sample and acts capillary stop requiring higher hydrodynamic forces of to allow restarting flow for washing steps.

In IBRI's PCT/US2020/055931 (the “IBRI PCT”), which is incorporated in its entirety by reference, an analyte detection microwell is described for electrochemical detection of target analytes which replaces the filtration membrane. The analyte detection microwell includes a size exclusion filter, electrochemical detector, and affinity agents for analyte capture and detection which operates under low hydrodynamic force without clogging with debris. The affinity agent for detection is attached to a reagent capable of generating an electrochemical label. The affinity agent for capture is attached to a reagent capable of binding a surface in the microwell. The electrochemical label is detected by a working and reference electrode placed in the microwell to measure labels formed by the affinity agent for detection. The IBRI PCT design allows precise containment of the small sample volumes into analyte detection microwell without loss of detection liquid, exposure to the environment or the need for a separate method for extraction, and delivery into an analyzer. However, a need still exists for a system and/or method for collecting and metering a sample, wherein the capillaries are of different sizes to allow for passage of debris while maintaining a hydrodynamic force.

### SUMMARY OF THE INVENTION

An object of an embodiment of the present disclosure is to reduce the hydrodynamic force of the sample capillary be within 2× of a liquid gathering capillary that is capable of emptying one or more reagent well with one or more analyte detection microwells with porous surfaces. This is achieved by application of porous matrix into the sample capillary capable of wicking retention. The porous matrix fills the sample capillary while still enabling removal of liquid at lower hydrodynamic force due to low adhesion of liquid under force. The force of 200 mbar or less may be used. In a further aspect, a force of 20 to 100 mbar or less as may be used.

Another object of an embodiment of the present disclosure is to allow a convenient and accurate way to collect sample by metering volume only to fill up the space of the wick upon only touching of a sample.

The collection and metering methods disclosed herein include: 1) touching sample to a porous matrix held in a sample well; 2) placing the sample well into a reagent well with one or more analyte detection microwells and; 3) connecting the reagent well into a filtration well with microfluidic liquid gathering capillary connected to a hydrodynamic force. The analyte detection microwell includes a porous surface, electrochemical detector, and affinity agents for capture and detection of a target analyte.

In a non-limiting embodiment, liquid is applied to the sample well with a porous matrix capillary containing a sample to remove target analytes by application of hydrodynamic force. The removed target analytes are then held and detected in a reagent well by the analyte detection microwell connected to a filtration well without a microfluidic capillary stop.

In a non-limiting embodiment of the present disclosure, hydrodynamic forces are connected to a waste collection chamber for application of hydrodynamic force by a connection to a vacuum. Hydrodynamic forces are maintained at the desired pressure in the waste collection chamber through the vacuum connection which allows driving the sample and/or liquid reagents through one or more pores of the analyte detection microwell of great than 100 microns with a porosity sufficient to pass complex sample under hydrodynamic forces.

In a non-limiting embodiment of the present disclosure, hydrodynamic forces of the analyte detection microwell are between the hydrodynamic forces are in-between the hydrodynamic forces of the sample capillary and microfluidic liquid gathering capillary allows the sample to be held in an analyte detection without a microfluidic capillary stop.

In a non-limiting embodiment of the present disclosure, the porous matrix allows metering and removal of sample from the sample well into the reaction well with an analyte detection microwell with hydrodynamic forces of around Δ 10 mbar change or greater, while still allowing flow though the microfluidic liquid gathering capillary at only a 2× stronger hydrodynamic force, such as Δ 20 mbar change. This allows adding liquids from the sample well into the porous matrix, and moving and further holding said liquid in the reagent well and filtration wells for reaction on the filtration membrane of analyte detection microwell. This allows the liquid gathering capillary to be of large size, so as not to clog and allow passage of liquids at low hydrodynamic forces. In some embodiments of the present disclosure, the liquid gathering capillary may be larger to be of weak hydrodynamic, for example, >1000 μm in diameter and non-resistive to debris.

In another embodiment of the disclosure, the pore area of the filtration membrane of analyte detection microwell could be less in size than the cross-sectional area of the sample capillary. This would allow holding more analyte in the detection microwell, and allow the analyte detection microwell to hold liquid when vacuum is not applied.

In other embodiments of the disclosure, the sample well is held by an analyst during sample collection, and the porous matrix is touched to the sample and absorbs the sample. For example, a 1.2 cm by 1.2 cm by 0.8 mm section of blotting paper may be used to wick in and hold 115 μL of sample, for example, a urine sample. The sample well is then snapped into the reaction well and connected to the vacuum by the analyst to allow processing of sample to be done. Once complete, the reaction well with detection microwell is removed and can be sealed in a biohazard bag and forwarded for confirmatory testing and further processing.

In other embodiments of the disclosure, the sample well is held by an analyst during sample collection, and a lancing device is touched to the surface and causes the sample drop to connect to a capillary absorbs the sample into porous matrix from the lancing device.

In some non-limiting embodiments or examples, the analyte captured and detected in analyte detection microwell is removed. In other non-limiting embodiments, the affinity agent for detection is attached to a reagent capable of generating an electrochemical label. In other non-limiting embodiments, the affinity agent for capture is attached to a reagent capable of binding a surface in the microwell. The electrochemical label is detected by a working and reference electrode placed in the microwell to measure the label formed by the affinity agent for detection.

Further, non-limiting embodiments or examples are set forth in the following numbered clauses.

Clause 1: A sample collection system comprising: a porous matrix; a microfluidic liquid gathering capillary; an analyte detection microwell, the analyte detection microwell having a filtration membrane; and a filtration well.

Clause 2: The sample collection system of clause 1, further comprising a reaction well.

Clause 3: The sample collection system of any of clauses 1 or 2, wherein the filtration membrane connects to the porous matrix and is attached to an upper portion of the reaction well.

Clause 4: The sample collection system of any of clauses 1-3, wherein the filtration well comprises a plurality of openings that allow connection to a waste chamber and a vacuum.

Clause 5: The sample collection system of any of claims 1-4, wherein the liquid gathering capillary; comprises of one ore capillaries and chambers, of equal or greater diameter.

Clause 6: The sample collection system of any of clauses 1-5, wherein the first capillary is 10 to 3000 μM in diameter.

Clause 7: The sample collection system of any of clauses 1-6, wherein the second capillary is

Clause 8: A method of releasing liquid from a sample collection system, the sample collection system having a porous matrix, a sample well, an analyte detection microwell having a filtration membrane, a reagent well, a filtration well, a waste chamber, and an outlet, the method comprising: adding sample to the porous matrix; adding a liquid to the sample well; and applying a vacuum to the vacuum connection until the liquid is removed to the reagent well.

Clause 9: The method of clause 8, wherein one or more liquid is released by breaking a seal allowing liquid to flow and air to vent.

Clause 10: The method of clause 8, wherein applying the vacuum to the vacuum connection removes the liquid to the waste chamber.

Clause 11: The method of any of clauses 8-10, wherein a affinity capture reagent is attached to the porous surface of the microwell.

Clause 12: The method of any of clauses 8-10, wherein an affinity agent is added to biomarkers to the porous matrix of the sample capillary.

Clause 13: The method of any of clauses 8-10, wherein the affinity agent comprises a microparticle with a diameter greater than the pore size of the porous surface and or the porous matrix.

Clause 14: The method of any of clauses 8-13, further comprising sensing of liquid movement by an electrode placed in the microwell.

Clause 15: The method of any of clauses 8-14, wherein the vacuum connection is attached to the filtration well.

Clause 16: The method of any of clauses 8-16, wherein the sample well is used to collect the sample prior to adding the sample to the reaction well.

Clause 17: The method of any of clauses 8-16, further comprising removing the sample well from the reagent well and the filtration well.

These and other features and characteristics of the present disclosure, as well as the methods of operation and functions of the related elements of structures, and the combination of parts, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

### BRIEF DESCRIPTION OF THE DRAWING(S)

FIG. 1 is a schematic view of a sample well and a porous matrix according to a non-limiting embodiment of the invention.

FIG. 2 is a schematic view of a reagent well and an analyte detection microwell according to a non-limiting embodiment of the invention.

FIG. 3 is a schematic view of a filtration well and a liquid gathering capillary according to a non-limiting embodiment of the invention.

FIG. 4 is a cross-sectional view of the sample and metering collection method in accordance with an embodiment of the invention.

FIG. 5 is a cross-sectional view of the sample and metering collection method according to another embodiment of the invention.

FIG. 6 shows a cross-sectional view of the entire sample and metering collection method in accordance with a non-limiting embodiment of the invention.

FIGS. 7 and 8 show a cross-sectional view of the sample and metering collection method in vertical (FIG. 7) and horizontal orientations (FIG. 8).

FIG. 9 is a schematic view of a filtration well and a liquid gathering capillary according to a non-limiting embodiment of the invention.

FIG. 10 shows a cross-sectional view of the entire sample and metering collection method in accordance with a non-limiting embodiment of the invention.

FIG. 11 shows a cross-sectional view of the entire sample and metering collection method in accordance with a non-limiting embodiment of the invention.

FIG. 12 is a schematic view of a filtration well and a liquid gathering capillary according to a non-limiting embodiment of the invention description of the invention

For the purpose of promoting an understanding of the principles of the invention, reference will now be made to the embodiments illustrated in the drawings, wherein like reference numbers correspond to like or functionally equivalent elements, and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. Certain embodiments of the invention are shown in detail, but some features that are well known, or that are not relevant to the present invention, may not be shown for the sake of conciseness and clarity.

For purposes of the description hereinafter, the terms “end,” “upper,” “lower,” “right,” “left,” “vertical,” “horizontal,” “top,” “bottom,” “lateral,” “longitudinal,” “forward,” “reverse” and derivatives thereof shall relate to the example(s) as oriented in the drawing figures. However, it is to be understood that the example(s) may assume various alternative variations and step sequences, except where expressly specified to the contrary. It is also to be understood that the specific example(s) illustrated in the attached drawings, and described in the following specification, are simply exemplary examples or aspects of the invention. Hence, the specific examples or aspects disclosed herein are not to be construed as limiting. Moreover, as used in the specification and the claims, the singular form of terms include plural referents unless the context clearly dictates otherwise.

For purposes of the description hereinafter, an analyte detection microwell (4) for electrochemical detection of target analytes is described in accordance with the IBRI PCT. The target analyte, porous surface, detection microwell, electrochemical detector, and affinity agents for analyte capture and detection are defined as terms and examples in accordance with the IBRI PCT. The materials and methods described herein are useful with any of a broad variety of target analytes. The target analytes include a wide range of target molecules and target cells. In addition, the target analytes may comprise one or more target variants, as described hereafter.

For purposes of the description hereinafter, the material for the sample, reagent, and filtration well used for housing the porous matrix for sample collection, holding the analyte detection microwell, liquids, and waste may be the same or different. The housing may be molded using plastics, but also may be constructed of non-porous glasses, ceramics, or metals. Examples of plastic materials for fabrication include polystyrene, polyalkylene, polycarbonate, polyolefins, epoxies, Teflon®, PET, cyclo olefin polymer (COP), cyclo olefin copolymer (COC), such as Topas®, chloro-fluoroethylenes, polyvinylidene fluoride, PE-TFE, PE-CTFE, liquid crystal polymers, Mylar®, polyester, polymethylpentene, polyether ketone (PEEK), polyphenylene sulfide, and PVC plastic films. The plastics can be metallized such as with aluminum. The housing can have a low moisture transmission rate, e.g. 0.001 mg per m²-day.

The housing may be several pieces permanently fixed by adhesion using thermal bonding, mechanical fastening, or through use of adhesives such as drying adhesives like polyvinyl acetate, pressure-sensitive adhesives like acrylate-based polymers, contact adhesives like natural rubber and polychloroprene, hot melt adhesives like ethylene-vinyl acetates, and reactive adhesives like polyester, polyol, acrylic, epoxies, polyimides, silicones rubber-based and modified acrylate and polyurethane compositions, and natural adhesives like dextrin, casein, and lignin. The plastic film or the adhesive can be electrically conductive and the conductive material can be patterned or coated across specific regions of the housing surface. The porous matrix attached to the housing by adhesion or pressure.

The porous matrix in the holder may generally be part of a filtration module where the porous matrix may be fabricated from a wide variety of materials, which may be naturally occurring or synthetic, polymeric or non-polymeric. Examples, by way of illustration and not limitation, of such for fabricating a porous matrix include plastics such as, for example, polycarbonate, poly (vinyl chloride), polyacrylamide, polyethylene, polyalkylacrylate, polyethylene, polypropylene, poly-(4-methylbutene), polystyrene, polyalkylmethacrylate, poly(ethylene terephthalate), nylon, poly(vinyl butyrate), poly(chlorotrifluoroethylene), poly(vinyl butyrate), polyimide, polyurethane, and parylene; silanes; silicon; silicon nitride; graphite; ceramic material (such, e.g., as alumina, zirconia, PZT, silicon carbide, aluminum nitride); metallic material (such as, e.g., gold, tantalum, tungsten, platinum, and aluminum); glass (such as, e.g., borosilicate, soda lime glass, and PYREX®); and bioresorbable polymers (such as, e.g., poly-lactic acid, polycaprolactone and polyglycoic acid); for example, either used by themselves or in conjunction with one another and/or with other materials. The material for fabrication of the porous matrix can also be comprised of porous plastics, porous foam, fibrous materials such as cellulose (including paper), nitrocellulose, cellulose acetate, rayon, diacetate, lignins, mineral fibers, fibrous proteins, collagens, synthetic fibers (such as nylons, dacron, olefin, acrylic, polyester fibers, for example), textile fibers, and bioderived materials, carboxymethyl cellulose (CMC), hydroxypropyl cellulose (HPC), hydroxyethyl cellulose (HEC), ethylcellulose (EC), and hydroxypropyl methylcellulose (HPMC) or, other fibrous materials (glass fiber, metallic fibers), which are bibulous and/or permeable and, thus, are not in accordance with the principles described herein. The material for fabrication of the porous matrix and holder may be the same or different materials.

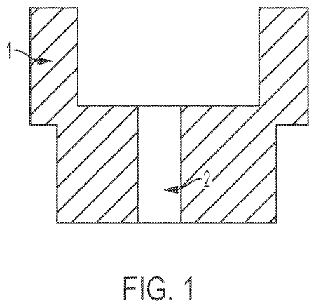

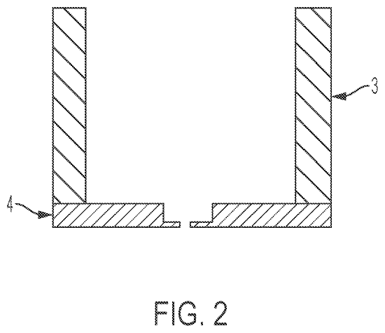

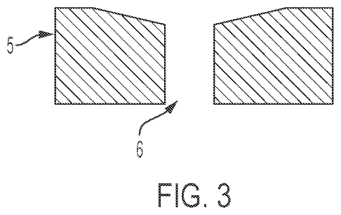

The following figures, with reference numbers that correspond to elements or correspond to functionally equivalent elements of the device, exemplify non-limiting embodiments or aspects of a system and method for sample collection and metering (FIGS. 1-4). In particular, the sample well (FIG. 1), reagent well (FIG. 2), and sample well (FIG. 3) are functional elements that may be used in combination for a method for sample collection and metering which is compatible with an analyte detection microwell for electrochemical detection of target analytes which includes a porous surface, electrochemical detector, and affinity agents for analyte capture and detection and which operates under low hydrodynamic force without clogging with debris. The affinity agent for detection is attached to a reagent capable of generating an electrochemical label. The affinity agent for capture is attached to a reagent capable of binding a surface in the microwell.

In FIG. 1 there is shown, in schematic form, a non-limiting embodiment or example of the sample well (1) component of a device which allows collection and metering of a sample into a porous matrix (2) upon contact with the sample. The porous matrix (2) meters the sample by absorbing a fixed volume defined by the amount of porous matrix (2). The porous matrix (2) absorbs the sample by capillary action into a sample well (1). The sample well (1) component allows removal of the metered amount of sample by application of vacuum below the porous matrix (2) to liquid applied above the porous matrix (2) to the top of the sample well (1). FIG. 1 shows the sample well (1) component in a vertical orientation, as a cross-sectional view of a cylinder. However, it is appreciated that the component is not limited to the shape of a cylinder, and can be other geometries, such as a cube or polygonal prism, or other orientations, such as horizontal or angled that would allow a sample access to the porous matrix (2).

In FIG. 2 there is shown, in schematic form, a non-limiting embodiment or example of the reagent well (3) component of device which allows extraction of sample with liquid from the porous matrix (2) of the sample well (1) component upon connection of the sample well (1) to the reagent well (3). The connection of the sample well (1) to the reagent well (3) allows application vacuum below the porous matrix (2). The reagent well (3) houses the analyte detection microwell (4) for electrochemical detection of target analytes. The analyte detection microwell (4) include a porous surface, electrochemical detector, and affinity agents for analyte capture and detection. FIG. 2 shows the reagent well (3) and analyte detection microwell (4) component in a vertical orientation and cross-sectional view of a cylinder. Again, it is appreciated that the component is not limited to the shape of a cylinder and can be other geometries, such as a cube or polygonal prism as preferred by user. The orientation of the reagent well (3) and analyte detection microwell (4) can be also horizontal or angled. As shown in FIG. 2, a vertical orientation of the analyte detection microwell (4), for example, may provide uniform coverage of electrochemical detection reagents on the analyte detection microwell (4) surface.

In FIG. 3 there is shown, in schematic form, a non-limiting embodiment or example of the filtration well (5) component of the device, which contains a microfluidic liquid gathering capillary (6) for holding liquid in the analyte detection microwell (4). A connection between the reagent well (3) and the filtration well (5) allows application of a vacuum below the analyte detection microwell (4). FIG. 3 shows the filtration well (5) and microfluidic liquid gathering capillary (6) components in a vertical orientation and cross-sectional cylinder view. In a non-limiting embodiment, the reagent well (3) and the filtration well (5) components of the device can be connected and/or formed as one piece with enclosed analyte detection microwell (4) with a porous surface and microfluidic liquid gathering capillary (6). In another non-limiting embodiment, the reagent well (3) and the filtration well (5) components may be separate components that are in contact with one another to form one piece. Again, it is appreciated that the component is not limited to the shape of a cylinder and can be other geometries, such as a cube or polygonal prism as preferred by the user. The orientation of the filtration well (5) can be also horizontal or angled, however it is preferred that the orientation of filtration well (5) is below the analyte detection microwell (4). In a further non-limiting embodiment or example, the liquid gathering capillary (6) can bend 90 degrees and exit horizontally to the side instead of vertically as shown in FIG. 3.

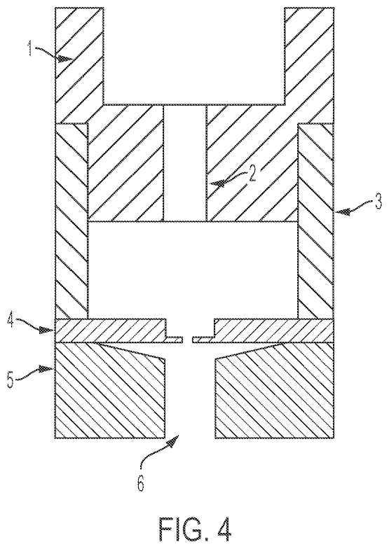

In FIG. 4 there is shown, in schematic form, a non-limiting embodiment or example of the sample well (1) component with the porous matrix (2) connected to the reagent well (3) with the analyte detection microwell (4) connected to the filtration well (5) component with a microfluidic liquid gathering capillary (6). In a non-limiting example, the sample well (1) with the porous matrix (2) may be inserted into the reagent well (3). In another embodiment, the sample well (1) and the reagent well (3) may be connected and/or formed as one piece. A hydrodynamic force can be applied via a vacuum from below the microfluidic liquid gathering capillary (6) or applied via a pressure from above the sample well (1).

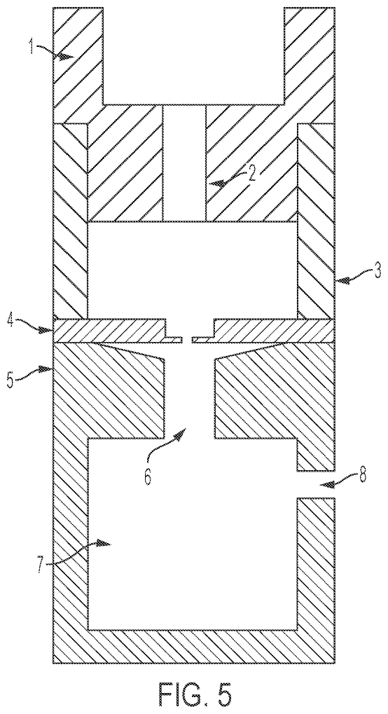

In a further non-limiting embodiment, FIG. 5 shows a means of application of the vacuum through a vacuum outlet (8) in a sealed waste chamber (7) placed below a microfluidic liquid gathering capillary (6). The orientation of the vacuum outlet (8) can be formed in any angle and positioned below the microfluidic liquid gathering capillary (6), as long as a hydrodynamic force can be applied below the microfluidic liquid gathering capillary (6). In a non-limiting embodiment or example, the waste chamber (7) may be connected and/or formed with the reagent well (3) and the filtration well (5) components of the device as one piece. Alternatively, it is appreciated that the reagent well (3) and the filtration well (5) can be separate but connected pieces which maintain a vacuum seal when connected.

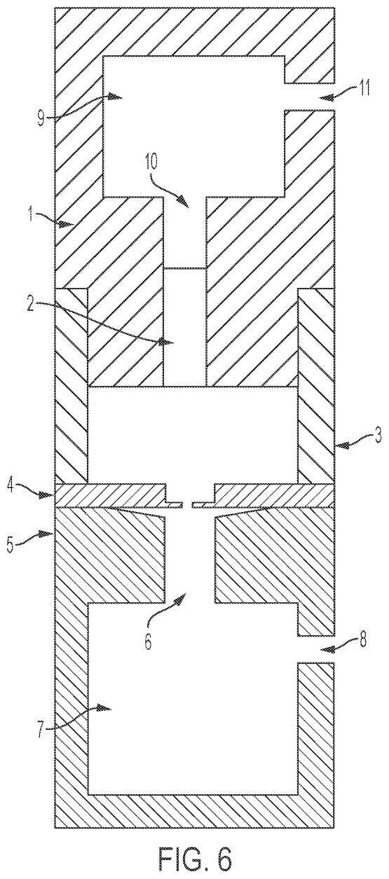

In FIG. 6 there is shown, in schematic form, a non-limiting embodiment or example of the means of application of the liquid through the porous matrix (2). Liquid may be introduced to the porous matrix (2) via a liquid chamber (9) through a chamber outlet (10) of the sample well (1) when a hydrodynamic force is applied as a vacuum to the vacuum outlet (8) in the waste chamber (7). In a non-limiting embodiment, the liquids chamber (9) may include an air vent (11) to facilitate movement of liquids in the sample well (1) when a hydrodynamic force is applied. The air vent (11) can be formed from any angle or configuration and positioned above the liquids in chamber (9) or the microfluidic liquid gathering capillary (6). In a non-limiting embodiment or example, dry reagents can also be sealed in the chamber outlet (10) to be mixed with the introduced liquid. In another non-limiting embodiment or example, the device may comprise two or more liquid chambers (9) that may hold the liquids until opening of the one or more air vents (11). The liquid chamber (9) may be formed and/or connected to the sample well (1) as one piece. However, it is appreciated that the liquid chamber (9) and the sample well (1) may be separate components that are intact.

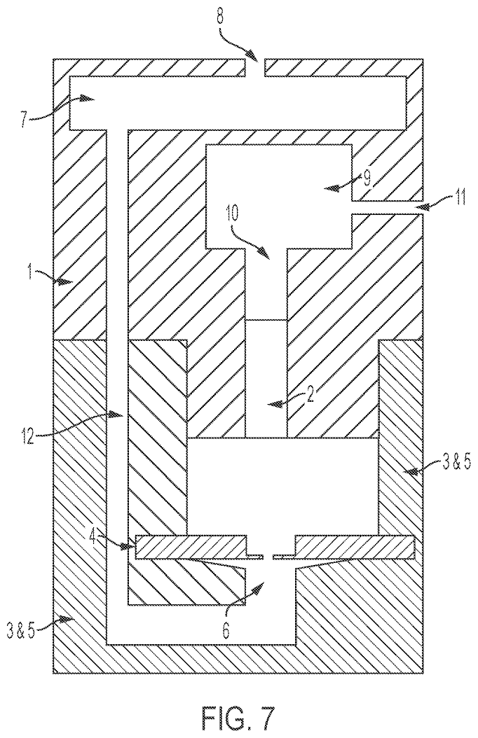

In FIG. 7 there is shown, in schematic form, a non-limiting embodiment or example of the sample well (1) component with a porous matrix (2) connected to the reagent well (3). The reagent well (3) with the analyte detection microwell (4) is connected to the filtration well (5) with the microfluidic liquid gathering capillary (6). FIG. 7 shows a non-limiting embodiment or example of the reagent well (3) connected to the filtration well (5) as one piece. FIG. 7 also shows the liquid chamber (9) connected to the sample well (1) as one piece. FIG. 7 also shows a waste chamber (7) connected to the sample well (1) components of the device as one piece. FIG. 7 illustrates that the exact configuration of the components of the device are not limited, as long as the flow of liquids is allowed as discussed above. It is further appreciated that all of the mentioned components may be separate that are intact with one another or connected and/or formed as one piece. It is appreciated that the configuration as shown in FIG. 7 allows the movement of the liquids in a similar manner. When hydrodynamic force is applied as a vacuum to the outlet (8) to the top of waste chamber (7), the waste enters the waste chamber (7) through a connecting capillary (12) connected below the microfluidic liquid gathering capillary (6) of the filtration well (4).

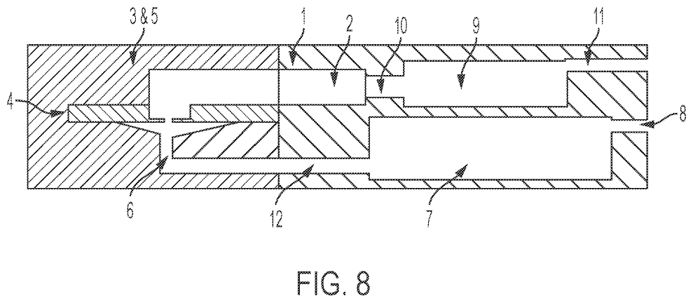

In FIG. 8 there is shown, in schematic form, a non-limiting embodiment or example of the device in a cross-sectional view in horizontal orientation of the device that forms a substantially rectangular shape to illustrate that the device is not limited to a specific configuration or shape. FIG. 8 is a non-limiting embodiment or example that further demonstrates that the device is not limited in its orientation. The filtration well (5) and microfluidic liquid gathering capillary (6) remain in vertical orientation to each other while the sample well (1), reagent well (3), and filtration well (5), as well as their sub-components, are orientated horizontal to each other. Similar to FIG. 7, FIG. 8 shows a non-limiting embodiment or sample of the sample well (1) sealed with one or more liquids in one or more chambers (9) to allow application of liquids to the porous matrix (2) for sample collection through the chamber outlet (10) which is vented (11) to allow air flow when hydrodynamic force is applied as a vacuum to the outlet (8). The reagent well (3), with analyte detection microwell (4), may be connected to a filtration well (5) as one piece or as separate components in contact. The waste can be collected in a waste chamber (7) sealed into the sample well (1) and connected below the microfluidic liquid gathering capillary (6) exiting the filtration well (5) through a connecting capillary (12) when vacuum is applied to the outlet (8).

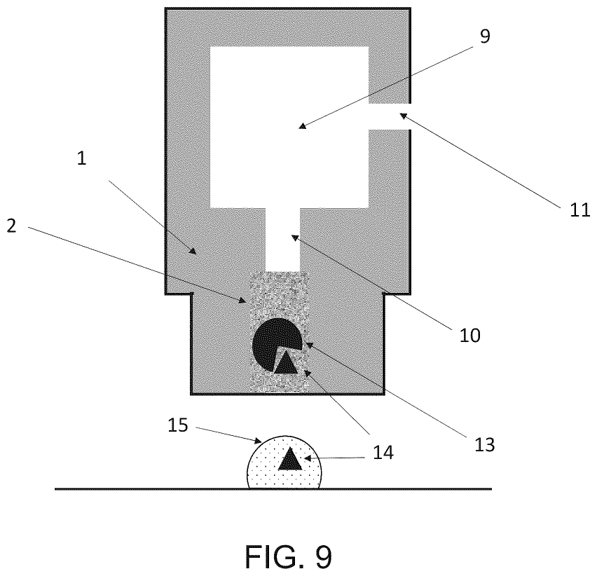

In FIG. 9 there is shown, in schematic form, a non-limiting embodiment or example of the means of application of the liquid through the porous matrix (2) where in an affinity agent (13) is added to the porous matrix and allows biomarkers (14) to be captured in porous matrix (2) when touched to a sample (15) of the liquid through the porous matrix (2). Liquid may be introduced to the porous matrix (2) via a liquid chamber (9) through a chamber outlet (10) of the sample well (1) when a hydrodynamic force is applied as a vacuum to the vacuum outlet (8) in the waste chamber (7). In a non-limiting embodiment, the liquids chamber (9) may include an air vent (11) to facilitate movement of liquids in the sample well (1) when a hydrodynamic force is applied, and the liquid may wash or release the biomarkers (14) captured by the affinity agent.

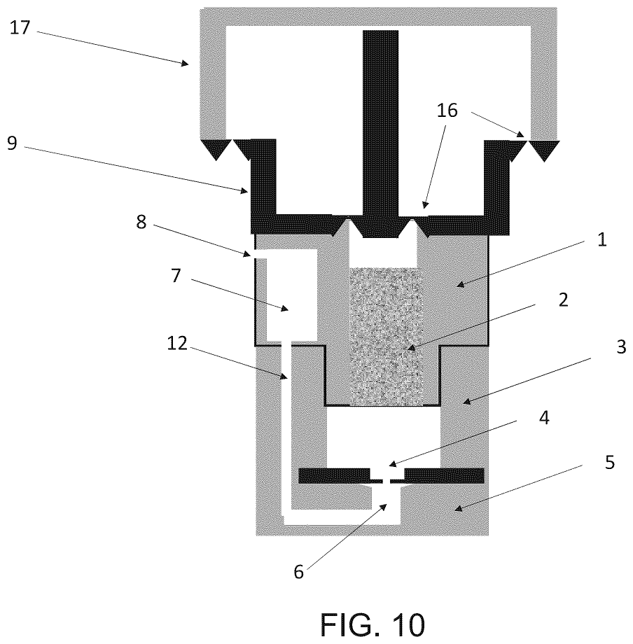

In FIG. 10 there is shown, in schematic form, a non-limiting embodiment or example of the sample well (1) component with a porous matrix (2) connected to the reagent well (3). The reagent well (3) with the analyte detection microwell (4) is connected to the filtration well (5) with the microfluidic liquid gathering capillary (6). FIG. 10 also shows the liquid chamber (9) connected to the sample well (1) as one piece and with breakaway points (16) in the wall that allow air to enter and liquid to leave when broken by pressing down on the cap (17). FIG. 10 also shows a waste chamber (7) connected to the sample well (1) components of the device as one piece. FIG. 7 illustrates that the exact configuration of the components of the device are not limited, as long as the flow of liquids is allowed as discussed above. It is further appreciated that all of the mentioned components may be separate that are intact with one another or connected and/or formed as one piece. It is appreciated that the configuration as shown in FIG. 7 allows the movement of the liquids in a similar manner. When hydrodynamic force is applied as a vacuum to the outlet (8) to the top of waste chamber (7), the waste enters the waste chamber (7) through a connecting capillary (12) connected below the microfluidic liquid gathering capillary (6) of the filtration well (4).

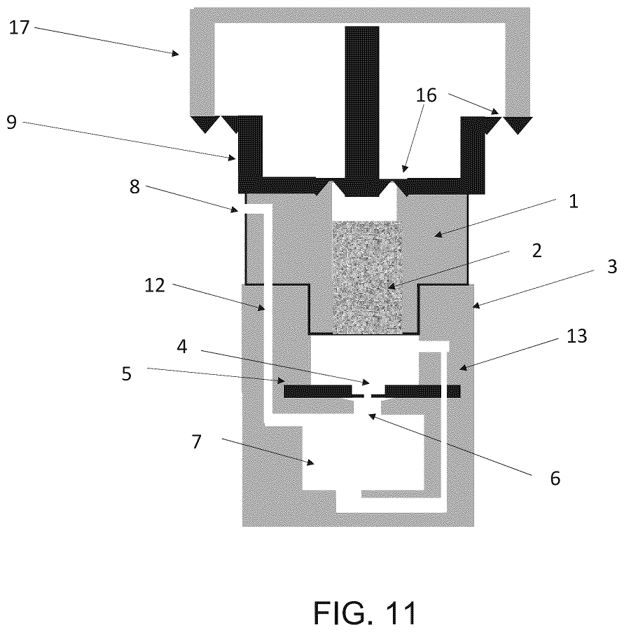

In FIG. 11 there is shown, in schematic form, a non-limiting embodiment or example of the sample well (1) component with a porous matrix (2) connected to the reagent well (3). The reagent well (3) with the analyte detection microwell (4) is connected to the filtration well (5) with the microfluidic liquid gathering capillary (6). FIG. 10 also shows the liquid chamber (9) connected to the sample well (1) as one piece and with breakaway points (16) in the wall that allow air to enter and liquid to leave when broken by pressing down on the cap (17). FIG. 10 also shows a waste chamber (7) connected to the sample well (1) components of the device as one piece. FIG. 7 illustrates that the exact configuration of the components of the device are not limited, as long as the flow of liquids is allowed as discussed above. It is further appreciated that all of the mentioned components may be separate that are intact with one another or connected and/or formed as one piece. It is appreciated that the configuration as shown in FIG. 7 allows the movement of the liquids in a similar manner. When hydrodynamic force is applied as a vacuum to the outlet (8) to the top of waste chamber (7), the waste enters the waste chamber (7) through a connecting capillary (12) connected below the microfluidic liquid gathering capillary (6) of the filtration well (4). An additional waste connecting capillary (13) can be used to circulate the mixture of materials through one or more analyte detection microwell (4) for a desired amount of time.

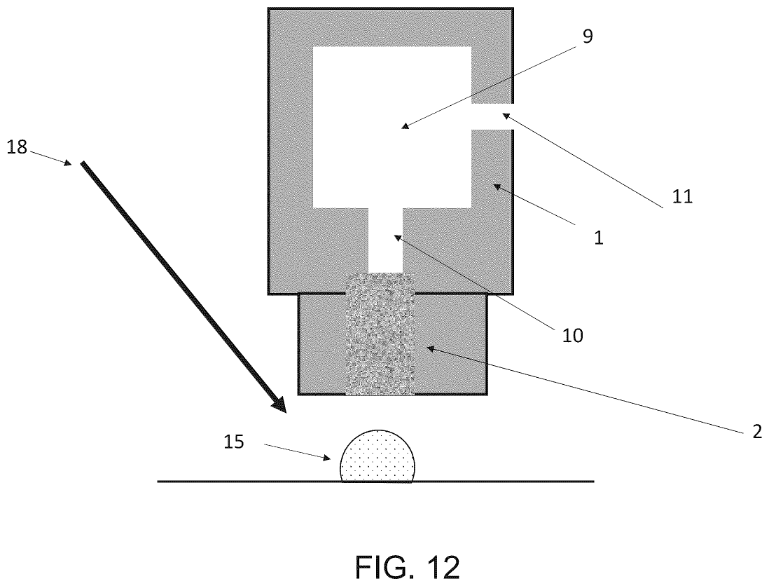

In FIG. 12 there is shown, in schematic form, a non-limiting embodiment or example of a sample well when it is held by an analyst to collect a sample (15), after a lance (18) was touched to the surface of skin and causes the sample (15) drop to form and is retracted into the sample well (1). The drop is absorbed into the sample well (1) upon contact with porous matrix (2) and application of the liquid through the porous matrix (2) occurs via a liquid chamber (9) through a chamber outlet (10) of the sample well (1). In a non-limiting embodiment, the liquids chamber (9) may include an air vent (11) to facilitate movement of liquids in the sample well (1) when a hydrodynamic force is applied to the porous matrix (2).

### EXAMPLE 1: METHOD FOR COLLECTION AND METERING OF COMPLEX SAMPLES

### Materials:

| | |
|---|---|
| Sample well (1), | The reagent, sample, and filtration wells were produced by CNS milling of |
| reagent well (3), | PEEK by fictiv (San Francisco, CA) according to design CAD produced by |
| and filtration well | BioMEMS Diagnostic Inc. as SAMPLE WELLS, REAGENT WELL, and |
| (5) | FILTRATION WELLs which all are representative of designs in FIGS. 1-3, |
| | and 10 as shown in a vertical cylinder orientation. Each liquid chamber was |
| | able to hold 1 mL. Up to three liquid chambers were included in the |
| | sample well. In the case of FIG. 10 breakaway points added and the |
| | liquid c The liquid gathering capillary at the bottom of the filtration well (5) |
| | was 6.6 mm in diameter. The reagent well (3) has a diameter of 9.5 mm and |
| | height of 14.5 mm for a usable volume of 1.1 mL. |
| Porous | Blotting paper Grade 623, with a basis weight of 246 g/m\hat{ }2, total |
| matrix (2) | absorbency 740 g/m\hat{ }2 and absorbency rate (capillary force) of 5 sec/1 |
| | mL water was used as porous matrix (2) and used as received from |
| | Ahlstrom- Munksjo (Mount Holly Springs, PA). The paper had thickness of |
| | ~800 μm without compression. The sample well (3) has a slot for holding |
| | the porous paper with compression at 736 microns thickness, 3 mm width, |
| | and 12.4 mm height. A paper of 3 mm width and 4.4 mm length section of |
| | blotting paper was used to wick in and hold 9.5 μL of sample in the porous |
| | matrix (2), for example, a urine or blood sample. Affinity agents for a |
| | target analyte for capture included in some cases according capture |
| | particles described in Pugia Anal Chem 2021 |
| Analyte detection | Analyte detection microwells (4) were fabricated by Vishay (Shelton, CT) |
| microwell (4) | as sensors described in IBRI PCT and included a porous surface with up to |
| | 10 pores diameter of 100 um to 200 um and electrodes that were |
| | connected to an electrochemical signal detector produced by BioMEMS |
| | Diagnostics Inc, and affinity agents for a target analyte for capture and |
| | detection included according the IBRI PCT. There are 10 analyte |
| | detection microwells (4) each of volume of 7.7 μL in sensor of 1.8 mm width |
| | by 8.3 mm height. Each analyte detection microwell (4) had a porosity of |
| | 0.03 to 0.12 mm\hat{ }2 and sensor area of 2.54 mm\hat{ }2 per microwell for total |
| | sensor porosity of 0.3 to 1.2 mm\hat{ }2 and a sensor area of 25.4 mm\hat{ }2 for all |
| | 10 microwells. |

Unless otherwise noted all other materials were purchased from Sigma Aldrich or Thermo Fisher Scientific.

### Method to Determine Sample Metering and Release

A non-limiting embodiment for metering and removal of samples was tested with specific reference to FIGS. 1-4 comprising application of a sample to a porous matrix (2) capable of absorbing 1 to 1000 μL volume in a sample well (1). The porous matrix (2) was 1 to 550 mm\hat{ }2 of blotting paper applied to the sample well (1) as a single pad of <1 cm by 1 cm or multiple layers of pad. Absorbing the sample was followed by connection of the sample well (1) to the reagent well (3) with 10 analyte detection microwells (4) of 7.7 μL volume and a filtration well (5) with microfluidic liquid gathering capillary (6) of 6.6 mm diameter by a press force. Liquid was applied to the top of the sample well (1) where it is open to allow application of the liquid and hydrodynamic force was applied to vacuum outlet. In this example, the hydrodynamic force was provided by a vacuum pump connected to a programmable controller board as described in IBRI PCT.

The ability of the sample well (1) to accurately pick up sample without the porous matrix (2) was compared to the sample well (1) with the porous matrix (2) expected to pick up. The amount of sample picked up was determined by added weight using a scale able to measure down to 0.001 mg. The sample well (1) with the porous matrix (2) was able to pick up the sample upon touching the sample in less than 1 sec within +/−0.04 μL at an pick volume of 1 μL and maintain a pick up accuracy of <4% up to 1 mL of sample in less than 5 sec. This was clearly better than the sample well (1) without the porous matrix (2) that was only able to pick up the sample at an average pick up accuracy of <10%. Whole blood, plasma, and urine all behaved similarly supporting the sample types described in IBRI PCT, and could be collected and metered into the sample well (1) with the porous matrix (2).

The ability of the sample well (1) with the porous matrix (2) to accurately release the sample was tested by adding a fixed amount FD &C blue 5 dye to the sample prior to pick up and determining the absorbance of the collected sample after correction for 10-fold dilution. A phosphate buffered saline (PBS) of 94 μL at pH 7.4 with 0.05% TWEEN-20 (PBS-T) was added to open top of the sample well (1) in the absence of vacuum connected to the reagent well (3) with the analyte detection microwell (4) and the filtration well (5) component with the microfluidic liquid gathering capillary (6). The hydrodynamic force was applied via a vacuum from below the microfluidic liquid gathering capillary (6) using a tube connected to underside of the filtration well (5). The sample well (1) with the porous matrix (2) was able to release 99%+/−0.3% of sample into a 50 mL waste container (7) connected to the vacuum tubing upon application of 10 mbar of vacuum and 96%+/−0.3% of sample upon application of 20 mbar of vacuum. This demonstrates the ability to meter and remove sample with common buffers and wash solutions. Whole blood samples consistently displayed a +/−0.3% loss of 21% of the original sample upon extraction. The consistency of the recovery however allowed for accurate metering of 79% of the expected volume. The selection of the porous materials can impact % of recovery, but would not be expected to improve the extraction precision significantly beyond the observed high precision of +/−0.3%.

### Method to Determine the Hydrodynamic Force Required

The vacuum pump connected to a programmable controller board as described in IBRI PCT was used with the sample well (1), the reagent well (3), the filtration well (5), the porous matrix (2), and the analyte detection microwell (4) to determine the Δ mbar of hydrodynamic forces needed for moving diluted sample from the sample well (1) into the reaction well (3) and through the filtration well (5). Whole blood and urine samples with debris were used to fill the porous matrix (2) and test for the ability of sample to pass through the sensor.

The ability of the microfluidic liquid gathering capillary (6) at the bottom of the filtration well (5) to hold the liquid in the analyte detection microwell (4) was tested with and without a capillary stop of 0.3 mm diameter and 2.0 mm length for a volume of 0.14 μL. Only as little as a Δ20 mbar change was needed for overcoming the microfluidic liquid gathering capillary (6) of 6 mm diameter. However, when microfluidic liquid gathering capillary decreased to capillary stop of 0.3 mm diameter, the Δ mbar change needed increased to >100 Δ mbar and the. At diameters of 0.3 mm or less clogging with sample debris occurred whereas at diameters of 1 mm or greater no sample debris was trapped.

Ability of the porous matrix (2) at the bottom of the sample well (1) to release liquid into liquid gathering capillary (6) and through the analyte detection microwell (4) tested with 100 to 1000 μL of samples in the porous matrix (2) and 1 to 3000 μL dilution buffer in the sample well (1). Surprisingly, only as little as a Δ 10 mbar change was needed for accurately releasing the sample form the porous matrix (2) to fill the reagent well (3) and the liquid stop at the microwells (4) and did not enter the filtration well (5). Surprisingly, this remained the case for a total sensor porosity of 0.1 to 2.0 mm\hat{ }2. A 2× stronger than hydrodynamic force of Δ 20 mbar was found overcoming the porous surface of microwells (4) and the sample completely exited the liquid gathering capillary (6) moving into the sealed waste chamber (7). The amount of the porous matrix (2) could be decreased to hold 1 μL or increased to hold 1000 μL, while still needing only the Δ 10 mbar change to accurately release the sample from the porous matrix (2) and a 2× stronger than hydrodynamic force of Δ 20 mbar from the microwell (4). The volume of the porous matrix (2) can be less than the volume of the liquid gathering capillary (6 and sealed waste chamber (7), e.g. volume of sample and liquid reagents. Hydrodynamic force of the porous matrix (2) could be least 20 mbar and still keep the below 2× hydrodynamic force to move the liquid to the waste chamber (9) while the hydrodynamic force to move the liquid to the waste chamber (9) could be and value greater than 20 mbar, e.g even 200 mbar.

It was also possible that the sample well (1) with porous matrix (2) full of sample can be snapped into the reagent well (3) and connected to the vacuum, waste and venting lines by the analyst to allow processing of sample to be done. This occurred with absence of any applied hydrodynamic force, or Δ 0 mbar change, allowed sample not be releases. Once snapped in adding additional liquid to the sample well (1) occurred with Δ 0 mbar change, preventing the additional liquid from mixing with sample or moving further into the reagent well (3) until at least a Δ 10 mbar change in hydrodynamic force was applied. This method of addition also worked after lancing the skin to form a drop with a lance (18) and retracting the lance (18) from the point of contact of the sample with porous matrix (2).

After snapping into place, a change of as little as Δ 10 mbar allowed the liquid to be mixed into the sample in the porous matrix (2) and moved the diluted sample from the porous matrix (2) into the reagent well (3) and into analyte detection microwell (4) but did not proceed past the analyte detection microwell (4). Application of a 2× additional hydrodynamic force, or Δ 20 mbar change, allowed the liquid to move from the analyte detection microwell (4) through the liquid gathering capillary (6) and the filtration well (5) to the waste chamber (9) towards the vacuum outlet (8).

During this process there was no need to remove the analyte detection microwell (4) which held entire diluted sample and detected the analyte. However, once the analysis was complete and the liquids were in the waste chamber (9), the reagent well (3) with the analyte detection microwell (4) could still be removed and can be sealed in a biohazard bag and forwarded for confirmatory testing and further processing.

The combined volumes of sample in the porous matrix (2) and liquid in the liquid chamber (10) were decreased to 1 μL and increased to 3000 μL and still could be full held in the analyte detection microwells (4) capable of hold all the liquid with an excess space of >20%. The hydrodynamic forces needed to move and stop sample and liquids through the sample well (1), the reagent well (3), and the filtration well (5) were not impacted by these changes to the sample volume in the porous matrix (2). Surprisingly, the cross-sectional area of the porous matrix (2) was as small as 2.4 mm\hat{ }3 and much less than the cross-sectional area of sensor area of 25.4 mm\hat{ }2 used in the analyte detection microwell (4) without impact to the hydrodynamic forces needed.

### Method to Determine Containment of Liquid and Waste

Further non-limiting embodiments for containment of liquids and waste were demonstrated by sealing a sample well (1) after application of a liquid in a sealed liquid chamber (9) through the chamber outlet (10) of the sample well (1) into the porous matrix (2). Venting the liquid chamber (9) was achieved by breakaway points (16) which once broken allow holes for an air vent (11) and allowed the liquid chamber (9) to be seal prior to application of hydrodynamic force. This sealing and opening process allows application of more than one liquid by use of multiple chambers in the sample well (1) to allow liquid to enter into the porous matrix (2) upon venting of each chamber. The breakaway occurred by mechanical pressure to a cap (17) adhered with adhesive to the sample well (1) as one piece without loss of function. Additionally, the filtration well (5) could be adhered with adhesive to the detection microwell (4) and the reagent well (3) as one piece without loss of function. Dye dried into liquid chamber outlet (10) was able to be dissolved by the liquid in the liquid chamber (9) and moved to the waste chamber (7) only upon venting the breakaway points (16) and application of hydrodynamic force. The waste chamber (7) could be part of sample well (1) allowing rerouting of waste back to be contained in the sample well (1) at the end of use for easy disposal.

In non-limiting embodiments or examples, as shown in FIG. 5, hydrodynamic forces are applied to the waste collection chamber (7) via application of a vacuum to the outlet (8). Hydrodynamic forces are maintained at the desired pressure in the waste collection chamber (7) through the vacuum via the outlet (8), which allows driving the sample and/or liquid reagents through a porous surface (5) of the analyte detection microwell (4). Removing this hydrodynamic force allows the sample to be held in analyte detection microwell (4) by the microfluidic liquid gathering capillary (6).

In non-limiting embodiments or examples, the analyte captured and detected in the analyte detection microwell (4) by an affinity agent for detection is attached to a reagent capable of generating an electrochemical label. In other non-limiting embodiments, the affinity agent for analyte capture was attached to a the porous surface in the microwell (4) to allow detection. In other non-limiting embodiments, affinity agent for analyte capture was attached to the porous matrix (2) to allow sample debris to be wash away with a wash liquid, such as PBS, and a second release liquid, such as a lysis buffer. In other non-limiting embodiments, the lysis buffer is to release the analyte to a sample collection vial. In other non-limiting embodiments, the affinity agent for analyte capture is attached to a reagent capable of binding a surface in the microwell (4). The electrochemical label may be detected by a working, counter and a reference electrode placed in the microwell (4) to measure the label formed by the affinity agent for detection as shown in IBRI PCT.

While the invention has been illustrated and described in detail in the drawings and foregoing description, the same is to be considered as illustrative and not restrictive in character, it being understood that only the representative embodiments have been shown and described and that all changes, equivalents, and modifications that come within the spirit of the inventions defined by the claims are desired to be protected. All publications, patents, and patent applications cited in this specification are herein incorporated by reference as if each individual publication, patent, or patent application were specifically and individually indicated to be incorporated by reference and set forth in its entirety herein.

1. A sample collection system comprising:
a porous matrix;
a microfluidic liquid gathering capillary;
at least one analyte detection microwell, the at least one analyte detection microwell having a porous surface; and
a filtration well.

2. The sample collection system of claim 1, further comprising a reaction well.

3. The sample collection system claim 1, wherein sample well connects to the reagent well with at least one analyte detection microwell and is attached to an upper portion of the reaction well.

4. The sample collection system claim 3, wherein the filtration well comprises a liquid gathering capillary that allows fluid connection to a waste chamber and vacuum.

5. The sample collection system of claim 1, wherein the microfluidic liquid gathering capillary comprises at least two capillaries, wherein a first and a second capillary of the liquid gathering capillary are same in diameter.

6. The sample collection system of claim 1, wherein the liquid gathering capillary is greater than 300 μM in diameter.

7. The sample collection system of claim 1, wherein the liquid gathering capillary is greater than 1000 μM in diameter.

8. A method of releasing liquid from a sample collection system, the sample collection system having a porous matrix, a sample well, an analyte detection microwell having a porous surface, a reagent well, filtration well, a waste chamber, and an outlet, the method comprising:
(a) adding sample to the porous matrix;
(b) adding a liquid to the sample well; and
(c) applying a vacuum to the vacuum connection until the liquid is removed to the reagent well.

9. The method of claim 8, wherein applying the vacuum to the vacuum connection removes the liquid to the waste chamber.

10. The method of claim 8, wherein a affinity capture reagent is added to the porous matrix and or porous surface.

11. (canceled)

12. The method of claim 8, wherein the affinity capture reagent comprises a microparticle with a diameter greater than the pore size of porous surface.

13. The method of claim 8, further comprising sensing of liquid movement by an electrode placed in the microwell.

14. The method of claim 8, wherein the vacuum connection is attached to the filtration well.

15. The method of claim 8, wherein the sample well is used to collect the sample prior to adding the sample to the reaction well.

16. The method of claim 8, further comprising removing the sample from the reagent well and the filtration well.

17. The method of claim 8, wherein the lancet is used to collect the sample into porous matrix prior to adding the sample to the reaction well.

18. The sample collection system of claim 1, wherein the microfluidic liquid gathering capillary comprises at least two capillaries, wherein a first and a second capillary are different in diameter.
